(19) United States
(12) Patent Application Publication
(10) Pub. No.: US 2021/0031918 A1
(43) Pub. Date: Feb. 4, 2021

(54) METHOD, CIRCUIT, AND DEVICE FOR MANAGING POWER SUPPLY

(71) Applicant: SZ DJI TECHNOLOGY CO., LTD., Shenzhen (CN)

(72) Inventor: Caihui ZHANG, Shenzhen (CN)

(21) Appl. No.: 17/069,246

(22) Filed: Oct. 13, 2020

Related U.S. Application Data
(63) Continuation of application No. PCT/CN2019/080174, filed on Mar. 28, 2019.

(51) Int. Cl. B64C 39/02; H02J 9/06

(52) U.S. Cl. CPC B64C 39/024; H02J 2310/44; B64C 2201/042; H02J 9/061

(57) ABSTRACT

A method for controlling power supply to a device includes detecting that the device is in a first operating state selected from a plurality of predetermined operating states. The method also includes generating, based on the detected first operating state of the device, a first control signal for controlling a state of a switch, the switch being configured to control a power source to provide power to the device when the switch is in a connected state, and not provide power to the device when the switch is in a disconnected state. The method further includes controlling the switch according to the first control signal regardless of a second control signal, wherein the second control signal is configured to control the state of the switch when the device is in a second operating state selected from the plurality of predetermined operating states.

### CROSS-REFERENCE TO RELATED APPLICATION

This application is a continuation of International Application No. PCT/CN2019/080174, filed Mar. 28, 2019, the entire content of which is incorporated herein by reference.

### TECHNICAL FIELD

The present disclosure relates to the technology field of power supply management and, more particularly, to a method, a circuit, and a device for managing power supply to an electronic device.

### BACKGROUND

Many electronic devices, such as surgical devices, aerial vehicles, such as unmanned aerial vehicles (UAVs), require constant power supply to avoid loss of power, which may result in accidents, damages, and injuries. For example, when a surgical device is activated, and a surgery is underway using the surgical device, it is critical that the power supply to the surgical device is uninterrupted. If the power supply is interrupted, the surgical device may cause injury to a patient.

Unmanned aerial vehicles also require constant power supply. UAVs have been widely used in various fields, such as agriculture, power line inspection, photography, surveillance, etc. Once the UAV is in an inflight state up in the air, it is important to ensure that a constant power supply is provided to a propulsion system of the UAV, which provides a lifting force. When the power supply to the propulsion system is interrupted, the propulsion system may stop working, resulting in the loss of the lifting force. As a result, the UAV may crash to the ground. Various situations may cause the UAV to lose constant power supply, for example, an event triggering a loss-of-voltage protection, an event triggering a current-overload protection, an event triggering a software bug protection, an event triggering a chip bug protection, etc.

Various methods have been implemented to improve the reliability of power supply. For example, a redundant power source may be provided to supply power in case a primary power source fails. However, providing a redundant power source, such as a backup battery, adds not only weight but also cost to the electronic device. Thus, redundant power source is often used in commercial airlines, rather than consumer level UAVs. Software based technology has also been developed. The software may detect that the UAV is in an inflight state. The software may attempt to ensure that a switch that turns on and off of the power supply is constantly activated, such that power is constantly provided from a battery to a propulsion system of the UAV 100. Although the software based technology may avoid abnormal power interruption caused by non-software related bugs and chip related bugs, the software based technology may not avoid power interruption caused by software related bugs, if the software per se has bugs in the codes. The software related bugs may cause power loss. In addition, although conventional technologies may include methods for dealing with power loss caused by microcontroller reset, effective methods are still lacking for preventing power loss caused by conflict in chip logics, bugs in chips, and static electricity.

Accordingly, there is a need to develop cost-effective methods, circuits, and devices for managing constant power supply to an electronic device.

### SUMMARY

An embodiment of the present disclosure provides a method for controlling power supply to a device. The method includes detecting that the device is in a first operating state selected from a plurality of predetermined operating states. The method also includes generating, based on the detected first operating state of the device, a first control signal for controlling a state of a switch, the switch being configured to control a power source to provide power to the device when the switch is in a connected state, and not provide power to the device when the switch is in a disconnected state. The method further includes controlling the switch according to the first control signal regardless of a second control signal, wherein the second control signal is configured to control the state of the switch when the device is in a second operating state selected from the plurality of predetermined operating states.

An embodiment of the present disclosure provides a method for controlling an unmanned aerial vehicle (UAV). The method includes generating, by a flight control device of the UAV, a signal indicative of an inflight state of the UAV. The method also includes providing the signal to a switch configured to control a supply of a power to the UAV to maintain the switch in a connected state when the UAV is in the inflight state.

An embodiment of the present disclosure provides an unmanned aerial vehicle (UAV). The UAV includes a propulsion system configured to provide a propulsion force for flight of the UAV. The UAV also includes a power source configured to supply power to the propulsion system. The UAV also includes a controller configured to control the power source when the UAV is not in flight. The UAV further includes a power control circuit coupled with at least one of the propulsion system, the power source, or the controller and configured to override the control of the power source by the controller when the UAV is in flight.

An embodiment of the present disclosure provides a power source. The power source includes a battery configured to supply a power to an electronic device. The power source also includes a switch coupled to the battery and configured to be changeable between a connected state and a disconnected state to allow and disallow the power to be supplied from the battery to the electronic device, the switch being controllable by a controller. The power source further includes an enabling circuit configured to enable or disable the control of the switch by the controller based at least in part on a state of the electronic device.

It shall be understood that different aspects of the present disclosure can be appreciated individually, collectively, or in combination with each other. Various aspects of the present disclosure described herein may be applied to any of the particular applications set forth below or for any other types of devices other than UAVs, including, for example, surgical devices or other devices that may require a constant power supply when operated. Any description herein of aerial vehicles, such as unmanned aerial vehicles, may apply to and be used for any other movable device, such as any other vehicle, including ground vehicles, water surface vehicles, underwater vehicles, and space vehicles.

Other objects and features of the present disclosure will become apparent by a review of the specification, claims, and appended figures.

### BRIEF DESCRIPTION OF THE DRAWINGS

The novel features of the present disclosure are set forth with particularity in the appended claims. A better understanding of the features and advantages of the present disclosure will be obtained by referencing to the following detailed description that sets forth illustrative embodiments, in which the principles of the present disclosure are utilized, and the accompanying drawings of which:

FIG. 1 is a schematic diagram of a UAV including a power source, in accordance with an embodiment of the present disclosure.

FIG. 2 is a schematic diagram of the UAV with a separate power source, in accordance with an embodiment of the present disclosure.

FIG. 3 is a schematic diagram of the UAV with a separate power source, in accordance with another embodiment of the present disclosure.

FIG. 4 is a circuit diagram of a first portion of a power control circuit, in accordance with an embodiment of the present disclosure.

FIG. 5 is a circuit diagram of a second portion of the power control circuit, in accordance with an embodiment of the present disclosure.

FIG. 6 is a circuit diagram of a first portion of the power control circuit, in accordance with another embodiment of the present disclosure.

FIG. 7 is a flow chart illustrating a method of controlling a power supply to a device, in accordance with an embodiment of the present disclosure.

FIG. 8 is a flow chart illustrating a method of controlling a power supply to a device, in accordance with another embodiment of the present disclosure.

FIG. 9 is a flow chart illustrating a method of controlling a power supply to a device, in accordance with another embodiment of the present disclosure.

FIG. 10 is a flow chart illustrating a method for controlling an unmanned aerial vehicle, in accordance with an embodiment of the present disclosure.

### DETAILED DESCRIPTION

Technical solutions of the present disclosure will be described in detail with reference to the drawings. It will be appreciated that the described embodiments represent some, rather than all, of the embodiments of the present disclosure. Other embodiments conceived or derived by those having ordinary skills in the art based on the described embodiments without inventive efforts should fall within the scope of the present disclosure. Example embodiments will be described with reference to the accompanying drawings, in which the same numbers refer to the same or similar elements unless otherwise specified.

As used herein, when a first component (or unit, element, member, part, piece) is referred to as “coupled,” “mounted,” “fixed,” “secured” to or with a second component, it is intended that the first component may be directly coupled, mounted, fixed, or secured to or with the second component, or may be indirectly coupled, mounted, or fixed to or with the second component via another intermediate component. The terms “coupled,” “mounted,” “fixed,” and “secured” do not necessarily imply that a first component is permanently coupled with a second component. The first component may be detachably coupled with the second component when these terms are used. The term “coupled” may include mechanical and/or electrical coupling. When a first item is electrically coupled with a second item, the electrical coupling may include any suitable forms of electrical connections, such as, for example, wired and wireless connections.

When a first component is referred to as “connected” to or with a second component, it is intended that the first component may be directly connected to or with the second component or may be indirectly connected to or with the second component via an intermediate component. The connection may include mechanical and/or electrical connections. The connection may be permanent or detachable. The electrical connection may be wired or wireless.

When a first component is referred to as “disposed,” “located,” or “provided” on a second component, the first component may be directly disposed, located, or provided on the second component or may be indirectly disposed, located, or provided on the second component via an intermediate component. When a first component is referred to as “disposed,” “located,” or “provided” in a second component, the first component may be partially or entirely disposed, located, or provided in, inside, or within the second component. The terms “perpendicular,” “horizontal,” “left,” “right,” “up,” “upward,” “down,” “downward,” and similar expressions used herein are merely intended for description. The term “communicatively coupled” indicates that related items are coupled through a communication channel, such as a wired or wireless communication channel.

Unless otherwise defined, all the technical and scientific terms used herein have the same or similar meanings as generally understood by one of ordinary skill in the art. As described herein, the terms used in the specification of the present disclosure are intended to describe example embodiments, instead of limiting the present disclosure. The term “and/or” used herein includes any suitable combination of one or more related items listed.

Further, when an embodiment illustrated in a drawing shows a single element, it is understood that the embodiment may include a plurality of such elements. Likewise, when an embodiment illustrated in a drawing shows a plurality of such elements, it is understood that the embodiment may include only one such element. The number of elements illustrated in the drawing is for illustration purposes only, and should not be construed as limiting the scope of the embodiment. Moreover, unless otherwise noted, the embodiments shown in the drawings are not mutually exclusive, and they may be combined in any suitable manner. For example, elements shown in one embodiment but not another embodiment may nevertheless be included in the other embodiment.

The following descriptions explain example embodiments of the present disclosure, with reference to the accompanying drawings. Unless otherwise noted as having an obvious conflict, the embodiments or features included in various embodiments may be combined. The following embodiments do not limit the sequence of execution of the steps included in the disclosed methods. The sequence of the steps may be any suitable sequence, and certain steps may be repeated.

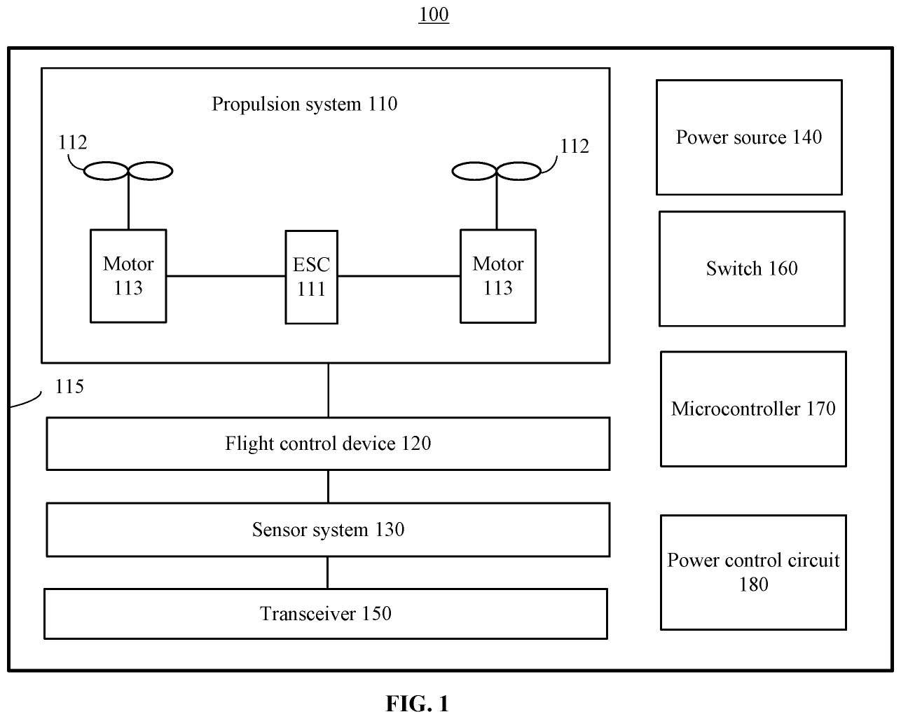

FIG. 1 is a schematic diagram of a UAV. Although for illustration purposes, UAVs are used throughout the following descriptions, the disclosed methods, circuits, and devices are not limited to implementations in UAVs. The disclosed methods, circuits, and devices for managing power supply may be used in other electronic devices, such as surgical devices, powered tools, powered ground vehicles, space vehicles, water surface vehicles, underwater vehicles, automated guided vehicles, etc.

As shown in FIG. 1, a UAV 100 may include a body 115. The body 115 may include a plurality of frames for mounting other devices, such as a power source, a flight control board, a gimbal, a sensor system, a communication device, etc. In some embodiments, the body 115 may include a plurality of arms radially extending from a central frame of the body 115. The UAV 100 may include a propulsion system 110 mounted to the body 115. The propulsion system 110 may include a plurality of propulsion assemblies each mounted to an arm. Each propulsion assembly may include a motor 113 and a propeller 112. In some embodiments, each propulsion assembly may also include an electronic speed control (“ESC”) 111. In some embodiments, an ESC 111 may be operably coupled with more than one propulsion assembly, e.g., more than one motor included in more than one propulsion assembly. In some embodiments, each propulsion assembly including the motor 113 and the propeller 112, and/or the ESC 111, may be mounted to a distal end portion or a tip portion of an arm.

The propulsion system 110 may be configured to provide a propulsion force (e.g., a lifting force and/or a thrust force) for the flight of the UAV 100. The propulsion system 110 may include any suitable number of propulsion assemblies, such as one, three, four, five, six, seven, eight, etc. In some embodiments, the motor 113 may be electrically and/or mechanically coupled between the ESC 111 and the propeller 112. The ESC 111 may be configured or programmed to receive a driving signal from a flight control device 120 included I the UAV 100. The ESC 111 may be configured to provide a driving current to the motor 113 based on the driving signal received from the flight control device 120, thereby controlling a rotating speed and/or a rotating direction of the motor 113. Each motor 113 may drive the propellers 112 to rotate, thereby providing a propulsion force for the flight of the UAV 100.

The UAV 100 may include a flight control device 120. The flight control device 120 may be operably coupled with various components or devices included in the UAV 100 through suitable mechanical and/or electrical couplings. The flight control device 120 may include various hardware, such as circuit, gate, chip, memory, processor, etc. The flight control device 120 may function as a central controller for controlling the flight and/or the operations of various components or devices included in the UAV 100. For example, the flight control device 120 may be configured to generate a driving signal for the ESC 111 to control the rotating speed and/or the rotating direction of the motor 113. The flight control device 120 may also control the pitch angle, the yaw angle, and the roll angle of the UAV 100 during flight. In some embodiments, the flight control device 120 may be configured to provide or generate a signal indicating the inflight state or the airborne state (an example of a first operating state) of the UAV 100. The signal may be provided from the flight control device 120 to a power control circuit 180 for managing a supply of a power, as described below. The first operating state may be a state in which the propulsion system 100 or any part of the propulsion system 100 is operating (e.g., the motor 113 is running).

The flight control device 120 may include at least one of a processor and a memory. The memory may be configured to store computer-executable instructions or codes. The memory may include any suitable memory, such as a flash memory, a random access memory (“RAM”), a read-only memory (“ROM”), a programmable read-only memory (“PROM”), a field programmable read-only memory (“FPROM”), etc. The processor may include any suitable processor, such as a central processing unit (“CPU”), a microprocessor, an application-specific instruction set processor (“ASIP”), a graphics processing unit (“GPU”), a physics processing unit (“PPU”), a digital signal processor (“DSP”), a network processor, etc. The processor may be a single-core processor or a multi-core processor. The processor may include various hardware components, such as circuits, gates, logic elements, etc. The processor may be configured to access the memory and execute the instructions stored therein to perform various methods disclosed herein, including the methods for controlling the movement (e.g., flight) of the UAV 100. In some embodiments, the flight control device 120 may include a hardware chip. The hardware chip may an application-specific integrated circuit (“ASIC”), a programmable logic device (“PLD”), or a combination thereof. The PLD may be a complex programmable logic device (“CPLD”), a field-programmable gate array (“FPGA”), a generic array logic (“GAL”), or any combination thereof.

The UAV 100 may include a sensor system 130 that may include any suitable sensors, such as a global positioning system (“GPS”) sensor, a real-time kinematic sensor, a visual-inertial odometry sensor, an inertial measurement unit, a microphone, an altitude sensor, a speed sensor, an accelerometer, an imaging sensor (e.g., included in an imaging device carried by the UAV 100), an infrared sensor, a digital compass, a radar, a laser sensor, a thermal sensor, a night vision sensor, etc. The sensor system 130 may acquire, collect, detect, or measure information relating to the UAV 100 and the environment in which the UAV 100 is operated. For example, the GPS sensor may provide location information of the UAV 100. The radar and/or laser sensor may provide a measurement of a distance between the UAV 100 and another neighboring UAV or obstacle. The flight control device 120 may receive measurement data from the various sensors, and may process the measurement data to obtain information relating to the state of the UAV 100. In some embodiments, the flight control device 120 may determine that the UAV 100 is in an inflight state based on processing the measurement data.

In some embodiments, the UAV 100 may include a transceiver 150 configured to communicate with a remote control device or terminal, a communication base station (such as a cellular telecommunication network), or a satellite. For example, the transceiver 150 may include at least one of a 3G, 4G, or 4G Long Term Evolution (“LTE”) communication chip, a 5G or 5G New Radio (“NR”) communication chip, a Bluetooth communication device, a Wi-Fi communication device, or any other communication devices that may provide a suitable range of communication. In some embodiments, the flight control device 120 may detect signals, through the transceiver 150, indicating a predetermined state of the UAV 100, such as the inflight state of the UAV 100. For example, the flight control device 120 may continuously receive commands from a remote control terminal controlling the flight of the UAV 100. Based on the receipt of the commands, the flight control device 120 may determine that the UAV 100 is in an inflight state.

As shown in FIG. 1, the UAV 100 may include a power source 140 configured to supply power to the UAV 100, including various loads of the UAV 100, such as the propulsion system 110. In some embodiments, the power source 140 may include a battery configured to supply electrical power to the electric motors 113 of the propulsion system 110. The battery may be any suitable battery, such as a rechargeable battery, a non-rechargeable battery, an alkaline battery, a Lithium Ion battery, a Nickel-Metal Hydride battery, a Nickel Cadmium battery, a lead acid battery, a Lithium Ion Polymer battery, etc. In some embodiments, the power source may include a solar panel and a battery. The solar panel may be configured to convert solar energy into electricity, which may be stored in the battery. The power source 140 may include any other suitable devices for providing the power to drive the propulsion assemblies included in the UAV 100. The power source 140 may be mounted on the body of the UAV 100. In some embodiments, the power source 140 may be detachably mounted on the UAV 100, and may be detached for replacement or service.

As shown in FIG. 1, the UAV 100 may include a switch 160 coupled to at least one of the power source 140, a controller 170 (which may be, for example, a microcontroller 170), or the propulsion system 110. The switch 160 may be configured to open and close (or be turned on and off, connected or disconnected, activated or deactivated, enabled or disabled) to allow and disallow the power to be supplied from the power source 140 to the UAV 100, such as the propulsion assemblies of the propulsion system 110. The electrical connections between the power source 140, the switch 160, the propulsion system 110, and other devices included in the UAV 100, are not shown for simplicity. A person having ordinary skill in the art can appreciate that various forms of electrical connections can be provided between the power source 140, the switch 160, the propulsion system 110, and other devices included in the UAV 100.

The switch 160 may include any suitable switch, such as a current-activated switch, a voltage-activated switch. In some embodiments, the switch 160 may include a metal oxide semiconductor field effect transistor (hereinafter referred to as a “MOS,” and the switch 160 may be referred to as a MOS switch 160). When a voltage of a signal supplied to an input of the MOS switch 160 satisfies a predetermined condition (e.g., being a high voltage that is higher than a predetermined voltage level, being a low voltage that is lower than a predetermined voltage level, or being within a predetermined voltage range), the MOS switch 160 may be activated (or connected, enabled, or turned on) to allow power to be supplied from the power source 140 to the UAV 100, such as the propulsion system 110. When the voltage of the signal provided at the input of the MOS switch 160 does not satisfy the predetermined condition, the MOS switch 160 may be deactivated (or disconnected, disabled, or turned off) to disallow the power to be supplied from the power source 140 to the UAV 100, such as the propulsion system 110. In some embodiments, the MOS switch 160 may be activated by a signal having a high voltage (a voltage that is higher than or equal to a predetermined voltage level). In some embodiments, the MOS switch 160 may be activated by a signal having a low voltage (a voltage that is lower than or equal to a predetermined voltage level). In some embodiments, the MOS switch 160 may be activated by a signal having a voltage within a predetermined voltage range.

When the MOS switch 160 is activated (or connected, turned on, or enabled), power may be allowed to be supplied from the power source 140 to other devices or circuits included in the UAV 100. When the MOS switch 160 is deactivated (or disconnected, turned off, or disabled), power may not be allowed to be supplied from the power source 140 to other devices or circuits included in the UAV 100.

The controller 170 (which may be, for example, a microcontroller 170) may include a processor and a memory. The memory may include any suitable memory, such as a flash memory, a random access memory (“RAM”), a read-only memory (“ROM”), a programmable read-only memory (“PROM”), a field programmable read-only memory (“FPROM”), etc. The processor may include any suitable processor, such as a central processing unit (“CPU”), a microprocessor, an application-specific instruction set processor (“ASIP”), a graphics processing unit (“GPU”), a physics processing unit (“PPU”), a digital signal processor (“DSP”), a network processor, etc. The processor may be a single-core processor or a multi-core processor. The processor may include various hardware components, such as circuits, gates, logic elements, etc. The processor may be configured to access the memory and execute the instructions stored therein to perform various methods disclosed herein, including the methods for controlling the power supply. In some embodiments, the microcontroller 170 may include a hardware chip. The hardware chip may an application-specific integrated circuit (“ASIC”), a programmable logic device (“PLD”), or a combination thereof. The PLD may be a complex programmable logic device (“CPLD”), a field-programmable gate array (“FPGA”), a generic array logic (“GAL”), or any combination thereof.

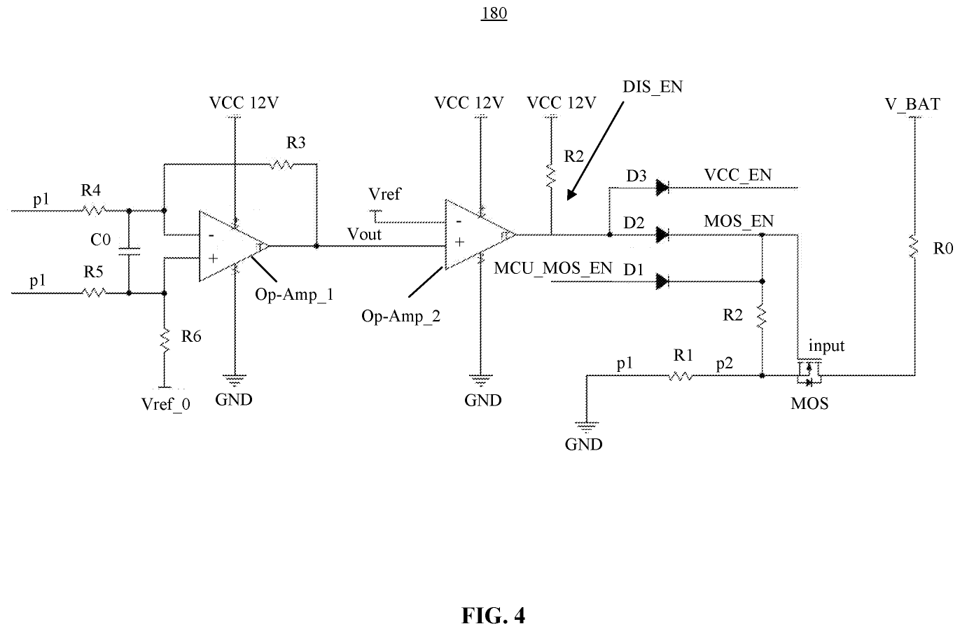

The microcontroller 170 may be configured to control various electrical elements, circuits, or devices in the UAV 100. For example, the microcontroller 170 may be configured to generate a signal to control (activate or deactivate) an electrical element, a circuit, or a device. The microcontroller 170 may be configured to control the power source 140 when the UAV 100 is not in flight. For example, when the UAV 100 is landed on the ground, the microcontroller 170 may generate a signal (e.g., MCU_MOD_EN shown in FIG. 4) to activate the MOS switch, such that the power source (e.g., V_BAT shown in FIG. 4) may supply power to the load R0 (which may represent the propulsion system 110).

In some embodiments, the microcontroller 170 may generate a switch control signal to control or change the states (e.g., the connected and disconnected states, activated and deactivated states, ON and OFF states, or enabled and disabled states) of the MOS switch 160. In other words, the microcontroller 170 may be configured to control the power supply from the power source 140 to other devices or circuits of the UAV 100, such as the propulsion system 110, by controlling the state of the MOS switch 160. In some embodiments, the microcontroller 170 may be configured to control the state of the MOS switch 160 when the UAV 100 is in a second operating state that is not an inflight state or not an airborne state (e.g., when the UAV 100 is on the ground before takeoff, or when the UAV 100 has landed on the ground). In some embodiments, in the second operating state, the propulsion system 100 or a portion of the propulsion system 100 is not running (e.g., the motor 113 is not running). When the MOS switch 160 is configured to be activated by a high voltage (a voltage higher than or equal to a predetermined voltage level), the microcontroller 170 may generate a switch control signal having a high voltage higher than or equal to the predetermined voltage level, and provide the switch control signal having the high voltage to the input of the MOS switch 160 for activating (or connecting, turning on, or enabling) the MOS switch 160. For example, prior to takeoff, the microcontroller 170 may generate a switch control signal having a high voltage (e.g., higher than a predetermined voltage) and provide the switch control signal to the input of the MOS switch 160 to place the MOS switch 160 in a connected state, thereby initiating the supply of the power from the power source 140 to the UAV 100, including the propulsion system 110.

In some embodiments, while the MOS switch 160 is in an activated (or connected, enabled) state, the microcontroller 170 may generate a switch control signal having a low voltage that is lower than the predetermined voltage level, and provide signal having the low voltage to the input of the MOS switch 160 for deactivating (or disconnecting, turning off, or disabling) the MOS switch 160. For example, after the UAV 100 has landed on the ground or floor, the microcontroller 170 may generate a switch control signal having a low voltage and provide the switch control signal to the input of the MOS switch 160 to place the MOS switch 160 in a disconnected state, thereby terminating the supply of the power from the power source 140 to the UAV 100, including the propulsion system 110.

Although for discussion purposes, the MOS switch 160 is described as being activatable by a signal having a high voltage, it is possible that the MOS switch 160 may instead be activatable by a signal having a low voltage. A person having ordinary skill in the art can appreciate how the MOS switch 160 may be activated (or connected, turned on) by a low voltage signal and deactivated (or disconnected, turned off) by a high voltage signal.

As shown in FIG. 1, the UAV 100 may include a power control circuit 180 electrically and/or mechanically coupled to at least one of the propulsion system 110, the power source 140, or the microcontroller 170. The power control circuit 180 may be configured to control the power supply from the power source 140 to other elements, devices, or circuits of the UAV 100. In some embodiments, the power control circuit 180 may control the power supply to the UAV 100 based on an operating state of the UAV 100. The UAV 100 may include various predetermined operating states, such as an inflight state when the UAV is flying in the air and the motor 113 is running, a powered-on state in which the UAV 100 is powered on, but the motor 113 is not supplied with power and is not running, and a powered-off state in which the UAV is powered off. A person having ordinary skills in the art can appreciate that the operating state may include other suitable state, such as a partially-powered-on state in which some components (e.g., the propulsion system 110, the flight control device 120, or a gimbal carried by the UAV 100) are powered on, but other components of the UAV 100 are not powered on. In some embodiments, the power control circuit 180 may be coupled with at least one of the propulsion system 110, the power source 140, or the microcontroller 170 and may be configured to override the control of the power source 140 by the microcontroller 170 when the UAV is in flight. For example, the power control circuit 180 may generate the DIS_EN signal in FIG. 4, which may override the MCU_MOS_EN signal generated by the microcontroller 170 in controlling the MOS switch when the UAV 100 is in flight.

For example, the power control circuit 180 may be configured to control the MOS switch 160 of the UAV 100. In some embodiments, the power control circuit 180 may maintain an activated (or connected or enabled) state of the MOS switch 160, thereby maintaining a constant power supply from the power source 140 to various devices, circuits, or elements of the UAV 100, including, for example, the propulsion system 110. The power control circuit 180 may enable a constant power to be supplied to the propulsion system 110 without interruption, which would otherwise occur in a conventional UAV due to various events or errors, such as an event triggering a loss-of-voltage protection, an event triggering a current-overload protection, an event triggering a software bug protection, an event triggering a chip bug protection, etc.

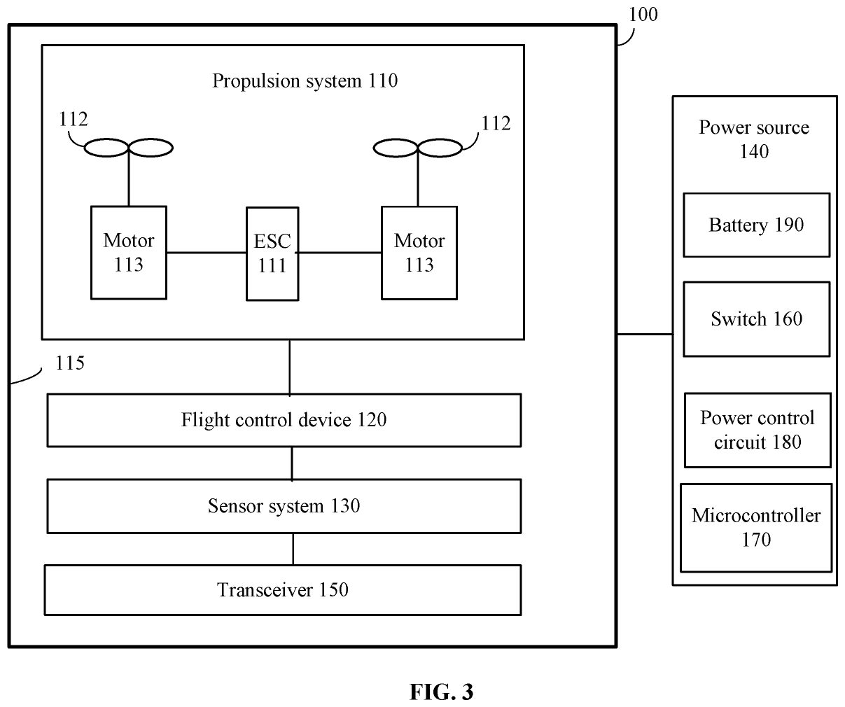

For example, with the disclosed power control circuit 180, a constant power supply to the propulsion system 110 may be maintained when the UAV 100 is in an inflight state, such that the propulsion system 110 does not lose power while the UAV 100 flies in the air. Thus, crash due to power loss may be avoided. The disclosed technology using the power control circuit 180 to maintain a constant power supply can avoid issues and disadvantages of conventional power supply management technologies. The disclosed technology is based on hardware circuits and can avoid power interruption caused by software bugs, which would occur in software based power management technology. In addition, the disclosed technology does not rely on chip logics to control the power supply. Therefore, the disclosed technology can avoid power loss that would otherwise occur due to bugs or conflicts in chip logics. Detailed exemplary circuit designs of the power control circuit 180 are shown in FIGS. 3-5, which are described below.

In some embodiments, the power control circuit 180 may detect that the UAV 100 is in a predetermined operating state, such as in an inflight state. For example, the power control circuit 180 may detect a signal indicating the predetermined operating state. Based on the signal, the power control circuit 180 may generate an enabling signal (which may also be referred as a first control signal) having a high voltage and use the enabling signal to activate the MOS switch 160 (e.g., placing the MOS switch 160 in a connected state). The enabling signal may be constantly provided by the power control circuit 180. Therefore, the MOS switch 160 may be maintained in a constantly connected state, which allows the power to be constantly supplied to the UAV 100. In some embodiments, the power control circuit 180 may generate the enabling signal while detecting that the UAV 100 is in an inflight state. While the MOS switch 160 is maintained in the connected state by the power control circuit 180, the control of the MOS switch 160 by the microcontroller 170 may be disabled. When the UAV 100 is not in an inflight state, e.g., when the UAV 100 is on the ground prior to takeoff, or when the UAV 100 has landed on the ground, the power control circuit 180 may not generate the enabling signal, or the enabling signal may not have a high voltage that satisfies a predetermined level. Thus, the power control circuit 180 may not control the state of the MOS switch 160. Accordingly, when the UAV 100 is not in the inflight state, the microcontroller 170 may be configured to control the state (e.g., the activated or deactivated, connected or disconnected, enabled or disabled, ON or OFF state) of the MOS switch 160.

In FIG. 1, the power source 140, the switch 160, the microcontroller 170, and the power control circuit 180 are shown as separate individual elements, and are all included in the UAV 100. In some embodiments, the power source 140, the switch 160, the microcontroller 170, and the power control circuit 180 may be combined in various forms. For example, in some embodiments, the switch 160 may be provided as part of the power source 140. In some embodiments, the switch 160 may be provided as part of the power control circuit 180. In some embodiments, the microcontroller 170 may be provided as part of the power control circuit 180. In some embodiments, the power control circuit 180, the switch 160, and the power source 140 may be provided as an integral package. In some embodiments, the power control circuit 180, the microcontroller 170, and the switch 160 may be provided as parts of the power source 140 in an integral package.

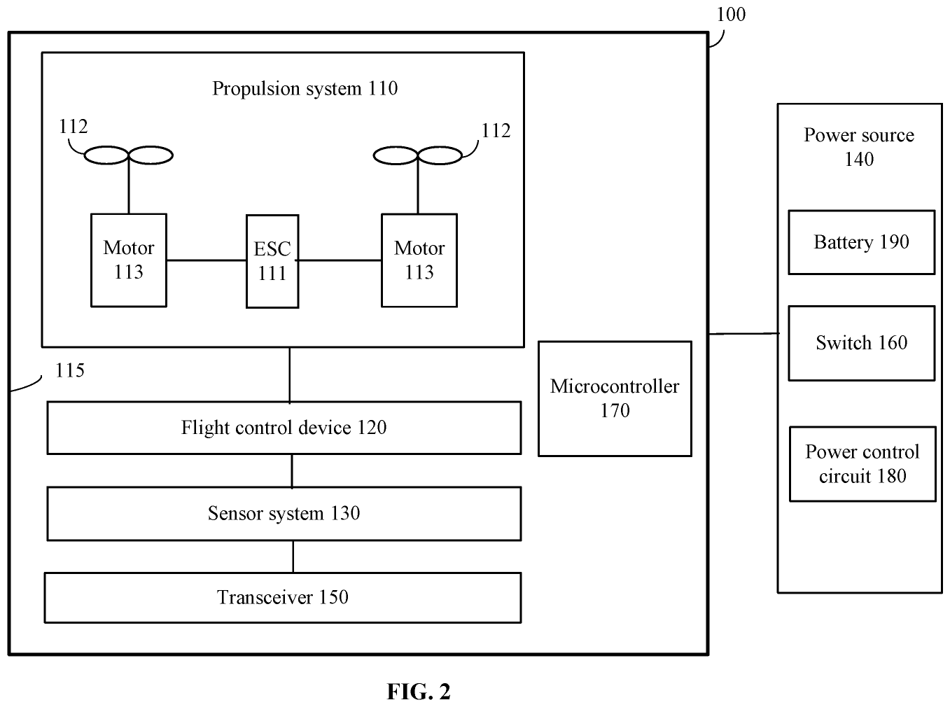

FIG. 2 is a schematic diagram of the UAV 100 with a separate power source 140. The power source 140 may include the switch 160 and the power control circuit 180 to maintain a constant power supply to the UAV 100 when the UAV 100 is in flight. The power source 140 may include a battery 190. The battery 190 may include any battery discussed above in connection with the power source 140 shown in FIG. 1. In some embodiments, the switch 160 may be provided on the UAV 100, rather than as part of the power source 140. The separate power source 140 may provide power to the UAV 100, and may be detachably mounted to the UAV 100. The power source 140 may be detached from the UAV 100 and be replaced with another power source. As shown in FIG. 2, the microcontroller 170 may be provided as part of the UAV 100, rather than as part of the power source 140.

FIG. 3 is a schematic diagram of the UAV 100 with a separate power source 140. In this embodiment, as compared to the embodiment of FIG. 2, the microcontroller 170 is also included in the power source 140. Thus, the power source 140 has the function of not only controlling the state of the switch 160 to provide a constantly connected state for the switch 160, but also providing a constant supply of a predetermined voltage to a plurality of electrical elements included in the power control circuit 180, which may be configured to generate an enabling signal for maintaining the constantly connected state for the switch 160, as discussed below. Such a power source 140 may be referred to as a smart power source, which may provide a constant supply of the power to the UAV 100, including the propulsion system 110, based on detecting a signal indicating that the UAV 100 is in a predetermined operating state, such as in an inflight state.

FIG. 4 is a circuit diagram of a first portion of the power control circuit 180. The MOS switch 160 is shown as “MOS.” The power source 140 is represented by “V_BAT” (also referred to as battery V_BAT for simplicity as the power source 140 may include a battery). R0, R1, R2, R3, R4, R5 represent resistors. Resistor R0 also represents a load in the UAV 100, such as electrical motors included in the propulsion system 110. The MOS switch 160 may be configured to control the power source 140 to provide power to the UAV 100 (e.g., load R0 of the UAV 100) when the switch is in a connected state and not provide power to the UAV 100 when the switch is in a disconnected state. “VCC_12V” represents a signal of a predetermined voltage (e.g., 12V, which may be other suitable voltage, such as 3.3V, 5V, 9V, etc.) supplied to a circuit portion or an electrical element. Some electrical elements may require a predetermined voltage level to operate normally. Thus, if the signal at the “VCC_12V” has a voltage lower than the predetermined voltage level or if the signal at the “VCC_12V” is lost, the electrical element (e.g., an operational amplifier, a DC-to-DC converter) may stop operating or may malfunction. “VCC_EN” represents a signal having a voltage supplied to an enabling pin of a power converter 44 shown in FIG. 4. “MOS_EN” represents a signal having a voltage supplied to an input of the MOS switch. The voltage of the signal represented by “MOS_EN” may control the connected and disconnected states of the MOS switch. “MCU_MOS_EN” represents a switch control signal (also referred as a second control signal) generated and supplied by the microcontroller 170 for activating (or deactivating), or connecting (or disconnecting) the MOS switch. The second control signal may be configured to control the state of the switch when the UAV 100 is in a second operating state selected from a plurality of predetermined operating states. The second operating state may be at least one of a powered-on state in which the UAV 100 is powered on, but the motor 113 is not supplied with power and is not running, a powered-off state in which the UAV 100 is powered off, or a partially-powered-on state in which some components (e.g., the propulsion system 110, the flight control device 120, or a gimbal carried by the UAV 100) are powered on, but other components (e.g., other sensors, such as GPS sensors, carried by the UAV 100). D1, D2, and D3 represent diodes. When a voltage on a left side (upstream side) of D1, D2, and D3 is a high voltage, the circuit branches including D1, D2, and D3 are connected. Otherwise, the circuit branches including D1, D2, and D3 are disconnected due to the high impedances of D1, D2, and D3.

As shown in FIG. 4, “DIS_EN” represents an enabling signal that may be generated by the power control circuit 180. DIS_EN signal may further be provided as “VCC_EN” and “MOS_EN” for controlling a power converter (shown in FIG. 4) and the MOS switch shown in FIG. 4. Thus, when DIS_EN signal has a high voltage, the signals VCC_EN and MOS_EN also have high voltages. In some embodiments, the voltages of DIS_EN, VCC_EN, and MOS_EN are the same. Characters “p1” and “p2” in the circuit are only used to designate nodes in the circuit across resistor R1. Characters “p1” and “p2” near R1 are connected to “p1” and “p2” near R4 and R5. C0 represents a capacitor. “GND” represents ground. “Op-Amp” represents operational amplifier. There are two operational amplifiers in the circuit, “Op-Amp_1” and “Op-Amp_2,” although the circuit may include only one operational amplifier, or more than two operational amplifiers. “Op-Amp_1” may function as an amplifier for amplifying a voltage signal, such as the voltage across resistor R1. An output of Op-Amp_1 is a signal Vout having a voltage. “Op-Amp_2” functions as a comparator that compares a voltage of a predetermined reference signal Vref with the voltage of Vout.

As shown in FIG. 4, certain electrical elements for generating the enabling signal DIS_EN may require a signal VCC_12V having a certain voltage to be supplied to the electrical elements such that the electrical elements may function properly. The electrical elements may be analog elements, which may include at least one of an operational amplifier, a comparator, a resistor. As shown in FIG. 3, Op-Amp_1 and Op-Amp_2 may require a signal VCC_12V of a certain voltage to function properly. Also as shown in FIG. 4, to generate DIS_EN, a signal VCC_12V of a predetermined voltage is supplied to the resistor R2. When the voltage of signal Vout is greater than the voltage of reference signal Vref, the comparator Op-Amp_2 may output the enabling signal DIS_EN having a high voltage (e.g., higher than or equal to a predetermined voltage level, such as 3.3V, 5V, 9V, 12V). The voltage of the enabling signal DIS_EN may be determined by the voltage of VCC_12V and the resistor R2. “Vref_0” represents another reference voltage that provides a voltage input to the positive pin of Op-Amp_1.

The battery (V_BAT) may provide a voltage, such as 10V, 20V, 30V, 40V, 50V, etc. When the MOS switch is disconnected or deactivated, load (R0) is not powered by the battery (V_BAT). When the MOS switch is connected or activated, the battery (V_BAT) provides power to the load (R0). The MOS switch may be activated or connected when a voltage supplied to an input of the MOS switch satisfies a predetermined condition. In some embodiments, the predetermined condition may be: the voltage supplied to the input is a high voltage (e.g., higher than or equal to a predetermined high voltage level, such as 0.8V, 1.2V, 3.3V, 5.0V, etc.). In some embodiments, the predetermined condition may be: the voltage supplied to the input is a low voltage (e.g., lower than or equal to a predetermined voltage level, such as 0.8V, 1.2V, 3.3V, etc.).

The power control circuit 180 (also referred to as an enabling circuit) can provide a constant power supply to the load of the UAV 100 when the UAV 100 is in flight. When the UAV 100 is on the ground (e.g., not in flight in the air), the microcontroller 170 may generate a switch control signal and provide the signal as MCU_MOS_EN through a second circuit branch including MCU_MOS_EN and D1. The signal MCU_MOS_EN, when having a high voltage, may pass through the diode D1 and be provided to the input of the MOS switch as MOS_EN having a high voltage. The MOS switch may be activated by the MOS_EN having the high voltage, thereby initiating the power to be supplied from the battery (V_BAT) to the load (R0). The load (R0) may be the propulsion system 110 or a portion of the propulsion system 110.

When the propulsion system 110 is in operation, the propulsion system 110 may provide a propulsion force for the UAV 100, such that the UAV 100 may take off from the ground. The current flowing through the load (R0) may increase as the UAV 100 takes off from the ground. Correspondingly, the voltage across the resistor R1 (an embodiment of a detecting element in the circuit that detects the UAV 100 in an inflight state) may increase. In some embodiments, a signal may be detected using the detecting element (for example resistor R1). The detected signal may indicate the operating state of the UAV 100. The detected signal may include at least one of a current flowing through the detecting element or a voltage across the detecting element. When the detected signal satisfies a predetermined condition, the detected signal may be used to generate an enabling signal for maintaining the MOS switch in a connected state, and for maintaining a predetermined voltage to be supplied to a plurality of electrical elements of the power control circuit 180. The predetermined condition may include the detected voltage across the detecting element (which may or may not be amplified) being greater than a predetermined reference voltage. In some embodiments, the predetermined condition may include the detected current flowing through the detecting element (which may represent the current flowing through the propulsion system that may be represented by the load R0) being greater than a predetermined current level.

For example, when the voltage across the resistor R1 is greater than or equal to a predetermined voltage level, the voltage can indicate that the UAV 100 is in flight. Hereinafter, the term “the voltage across the resistor R1” or “across the detecting element” refers to the actual detected voltage or a voltage that is an amplification of the detected voltage. As shown in FIG. 4, the signal (having a voltage) measured at the resistor R1 is supplied to the amplifier formed by Op-Amp_1. After the voltage of the signal across the resistor R1 is amplified, it becomes the voltage of Vout. For simplicity, the voltage of Vout may also be referred to as the voltage across the resistor R1. The voltage of Vout is compared to a voltage of a predetermined reference signal Vref by the comparator formed by Op-Amp_2. When the voltage of Vout is greater than the voltage of Vref, the comparator outputs a high voltage DIS_EN (a voltage that is higher than or equal to a predetermined high voltage threshold). When the voltage of Vout is smaller than the voltage of Vref, DIS_EN may have a low voltage (a voltage that is lower than a predetermined low voltage threshold).

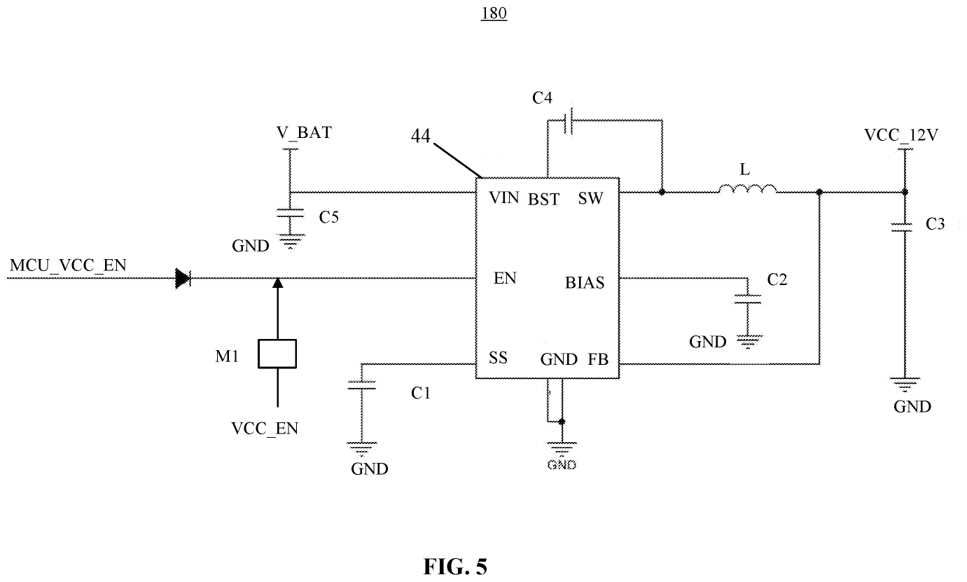

When signal DIS_EN has a high voltage, MOS_EN also has a high voltage. MOS_EN is provided to the input of the MOS switch, which places the MOS switch in an ON (or activated or connected) state. When the voltage of DIS_EN is constantly maintained at a high voltage level, MOS_EN is constantly maintained at a high voltage level. Hence, the MOS switch is constantly maintained in the ON (or activated or connected) state. When the MOS switch is constantly maintained in the activated (or connected) state, power from the battery (V_BAT) is constantly supplied to the load (R0), such as the propulsion system 110. Therefore, the disclosed power control circuit 180 can provide a constantly power supply to the load (R0), thereby avoiding power loss to the propulsion system 110. In some embodiments, the signal DIS_EN may be referred to as an enabling signal, which may be used to place the MOS switch in a connected state such that a constant power supply to the load (R0) is enabled. The enabling signal DIS_EN may also be supplied to the second portion of the power control circuit 180 shown in FIG. 4 as VCC_EN through a third circuit branch to enable a power converter 44 shown in FIG. 5, such that a constant power supply VCC_12V is provided to a plurality of analog electrical elements, such as Op-Amp_1, Op-Amp_2, and resistor R2, such that these elements can function properly for providing a constantly high voltage DIS_EN.

As shown in FIG. 4, the input of the MOS switch is connected with two circuit branches that are arranged in parallel with each other. The first circuit branch is the branch with DIS_EN, D2, and MOS_EN. The second circuit branch is the branch with MCU_MOS_EN, D1, and MOS_EN. In some embodiments, when MCU_MOS_EN generated and provided by the microcontroller 170 is a high voltage signal (e.g., having a voltage higher than a predetermined voltage), MOS_EN is also a high voltage signal, and the MOS switch is placed in a connected state. When DIS_EN is a high voltage signal, and MCU_MOS_EN is a low voltage signal, because the second circuit branch with MCU_MOS_EN, D1 may be deemed as disconnected due to the high impedance of diode D1, the MOS_EN signal is affected only by the high voltage signal DIS_EN, and is not affected by the low voltage signal MCU_MOS_EN. Thus, even when MCU_MOS_EN is a low voltage signal, MOS_EN is still a high voltage signal. In other words, when the UAV 100 is in flight, even if an event occurs to the microcontroller 170 that causes the microcontroller 170 to generate a low voltage signal at MCU_MOS_EN, as long as DIS_EN has a high voltage, the MOS_EN has a high voltage, and the MOS switch can be maintained in the connected or activated state, allowing the power from the battery (V_BAT) to be constantly supplied to the load (R0). Thus, when the power control circuit 180 maintains the MOS switch in a connected state based on detection of the UAV 100 in the inflight state, the control of MOS switch by the microcontroller 170 may be disabled.

The control of the MOS switch by the microcontroller 170 may resume when the UAV 100 lands on a ground and is no longer in the inflight state. The microcontroller 170 may generate a switch control signal (e.g., a high voltage signal) to place the MOS switch in a connected state to initiate the supply of the power to the UAV 100, such as the propulsion system 110, prior to the takeoff of the UAV 100. In some embodiments, the microcontroller 170 may generate another switch control signal (e.g., a low voltage signal) to place the MOS switch in a disconnected state to terminate the supply of the power to the UAV 100, such as the propulsion system 110, after the UAV 100 has landed on the ground or floor.

Referring to FIG. 4, when the UAV 100 is in flight, a signal may be detected by or at the detecting element R1. The detected signal, which may be further amplified, may be compared with a predetermined reference signal. The power control circuit 180 may generate an enabling signal DIS_EN based on comparing the detected signal and the predetermined reference signal. Detecting the signal may include measuring a voltage across the detecting element, or measuring a current flowing through the detecting element. Comparing the detected signal with the predetermined reference signal may include comparing a voltage of the detected signal with a voltage of the predetermined reference signal, or comparing a current of the detected signal with a current associated with the predetermined reference signal. For simplicity of discussion, the following descriptions use comparison of voltages as an example.

In some embodiments, as shown in FIG. 4, a voltage across the detecting element, resistor R1, may be detected. As the power is provided to the load (R0), which may be the propulsion system of the UAV 100, the voltage across R1 may increase. At a certain time (e.g., after the UAV 100 has taken off), the voltage may be sufficiently high to produce a high voltage signal DIS_EN through the portion of the circuit comprised of the two operational amplifiers Op-Amp_1 and Op-Amp_2. Thus, when the UAV 100 is in flight, this portion of the power control circuit 180 can maintain a constantly connected state for the MOS switch, which in turn maintains a constant power supply to the load (R0). Through this portion of the power control circuit 180, the control of the MOS switch by the microcontroller 170 is disabled when the UAV 100 is in flight because even if the MUC_MOS_EN has a low voltage, as long as DIS_EN has a high voltage, MOS_EN has a high voltage, which places the MOS switch in a connected state. The control of the MOS switch by the microcontroller 170 is restored when the UAV 100 is not in flight (e.g., landed on the ground), such that the voltage across the resistor R1 is not sufficient to generate a signal Vout that has a voltage greater than the voltage of the predetermined reference signal Vref. As a result, signal DIS_EN has a low voltage, and the second circuit branch comprised of DIS_EN, D2 may be deemed as disconnected due to the high impedance of diode D2. In such a situation, the microcontroller 170 may control the on/off (connected/disconnected or activated/deactivated) state of the MOS switch by generating different signals at MCU_MOS_EN.

Although voltage is used in the above descriptions of the embodiment shown in FIG. 4, in some embodiments, the detected signal (e.g., signal at R1) may be based on current instead of voltage. In some embodiments, the comparison between Vout and reference signal Vref may be replaced with a comparison between a detected current and a reference current. In some embodiments, when the voltage across the detecting element R1 is sufficiently high, a current measured at R1 is also sufficiently high, indicating that the current output from the battery (V_BAT) is larger than a predetermined current level. Thus, when the power control circuit 180 detects that the current output from the battery is greater than a predetermined current level, the power control circuit 180, by generating a high voltage DIS_EN signal, may maintain the MOS switch in a connected state, thereby disabling the control of the MOS switch by the microcontroller 170. A person having ordinary skill in the art can modify the disclosed power control circuit 180 to change the detection and comparison based on voltage to detection and comparison based on current.

To provide a constant power supply to the load (R0), the MOS switch may be constantly connected. In some embodiments, a high voltage may be constantly supplied to the input of the MOS switch in order to maintain the MOS switch in the constantly connected state. The portion of the power control circuit 180 shown in FIG. 4 can maintain the constantly connected state for the MOS switch when the UAV 100 is in flight. The constantly connected state may be achieved if a direct current (DC) power supply VCC_12V is constantly provided to a plurality of electrical elements included in the portion of the power control circuit 180 for maintaining the constantly connected state of the MOS switch. To constantly provide a predetermined voltage VCC_12V to the plurality of electrical elements, the power control circuit 180 may include a second circuit shown in FIG. 5.

FIG. 5 shows a second portion of the power control circuit 180. C1, C2, C3, C4, and C5 represent capacitors. “L” represents an inductor. “MCU_VCC_EN” represents a power control signal generated by the microcontroller 170. M1 represents a circuit block. Element 44 represents a power converter 44. Power converter 44 may be any converter that can convert a high voltage to a low voltage, such as a DC-to-DC power converter. The “EN” pin in power converter 44 may be an enabling pin. When a voltage of a predetermined level is supplied to the enabling pin (EN), the power converter 44 is enabled to convert a first voltage (e.g., a higher voltage) to a second voltage (e.g., a lower voltage). In some embodiments, when the enabling pin (EN) is provided with a high voltage (higher than a predetermined voltage level, e.g., 0.88V, 1.2V, etc.), the power converter 44 is enabled to reduce the battery DC voltage V_BAT to a lower DC voltage at VCC_12V (e.g., 3.3V, 5.0V, 9V, 12V). When the enabling pin (EN) is provided with a low voltage (lower than the predetermined voltage level, e.g., 0.88 V, 1.2 V, etc.), the power converter 44 may be disabled, outputting a low DC voltage or zero voltage at VCC_12V. A person having ordinary skill in the art can appreciate the operational principles of a DC-to-DC power converter. Therefore, the detailed descriptions of the power converter 44 are omitted. It is understood that the DC-to-DC power converter 44 may be replaced with any suitable power converter that can provide a voltage of a predetermined level at VCC_12V.

The VCC_EN shown in FIG. 5 is connected to the VCC_EN shown in FIG. 4. As shown in FIG. 4, the signal DIS_EN provides the signal VCC_EN. Thus, when the signal DIS_EN has a high voltage (e.g., higher than a predetermined high voltage level), VCC_EN also has a high voltage. The high voltage VCC_EN is supplied to an enabling pin (EN) of the power converter 44 through the circuit block M1 to enable the power converter 44 to convert a high DC voltage to a low DC voltage. Various components, elements, devices, or circuit portions of the power control circuit 180 shown in FIG. 4 may require a DC power supply to function properly, as indicated by VCC_12V. In some embodiments, when VCC_12V is a low voltage or zero voltage, the pertinent components, elements, devices, or circuit portions may not function properly, or may stop functioning, resulting in a low voltage at MOS_EN that may disconnect the MOS switch, which terminates the power supply to the load (R0). Thus, to maintain a constant DC power supply of a predetermined voltage at VCC_12V for some electrical elements, such as those included in FIG. 4, the second circuit shown in FIG. 5 can be used in combination with the circuit shown in FIG. 4.

With the power control circuit 180 shown in FIGS. 4 and 5, when the UAV 100 is in flight, the voltage across the resistor R1 may be sufficiently high to produce a high voltage (at Vout) that is greater than a voltage of a predetermined reference signal Vref. When the voltage of Vout is greater than the voltage of Vref, a predetermined high voltage may be generated at DIS_EN. The high voltage DIS_EN produces a high voltage MOS_EN, as well as a high voltage VCC_EN. The high voltage MOS_EN maintains the MOS switch in a constantly connected state. In some embodiments, the high voltage VCC_EN is input to the enabling pin (EN) of the power converter 44 through the circuit block M1, enabling the power converter 44 to constantly provide a voltage at VCC_12V, which may be required by various components, devices, electrical elements, or circuit portions shown in FIG. 4 (such as the Op-Amp_1, Op-Amp_2, and R2) to function properly, such that they may provide a constantly high voltage DIS_EN.

Therefore, the power control circuit 180 of FIG. 4 and FIG. 5 provides control of the MOS switch by providing a constantly high voltage to the MOS switch to maintain the MOS switch in a connected state when the UAV 100 is in flight. The power control circuit 180 also provides control of the power supply at VCC_12V for a plurality of electrical elements, such that the electrical elements for providing control of the MOS switch can function properly.

As shown in FIG. 5, the enabling pin (EN) of the power converter 44 also receives a signal MCU_VCC_EN generated by the microcontroller 170. Thus, two parallel circuit branches supply a voltage to the enabling pin of the power converter 44, respectively. The circuit branch associated with signal VCC_EN generated by the first portion of the power control circuit 180 shown in FIG. 4 (third circuit branch), and the circuit branch associated with signal MCU_VCC_EN generated by the microcontroller 170 (fourth circuit branch). When VCC_EN provides a high voltage to the enabling pin (EN) of the power converter 44 through the circuit block M1, the power converter 44 is enabled, regardless of the signal level of MCU_VCC_EN. In other words, when the VCC_EN is maintained to have a high voltage, the power converter 44 is constantly enabled to constantly provide a predetermined voltage at VCC_12V, even if the microcontroller 170 outputs a low voltage at MCU_VCC_EN.

When VCC_EN has a low voltage (e.g., when the UAV 100 is not in flight, e.g., after landed on ground or prior to takeoff), the second circuit branch comprised of VCC_EN and M1 may be disconnected (or deemed disconnected due to the high impedance of M1, which may include a diode). The microcontroller 170 may control the enabled and/or disabled states of the power converter 44 by changing the signal at MCU_VCC_EN. For example, when VCC_EN has a low voltage, the microcontroller 170 may generate a power control signal that has a high voltage at MCU_VCC_EN, and provide the high voltage signal MCU_VCC_EN to the enabling pin (EN) of the power converter 44 to enable the power converter 44. As a result of enabling the power converter 44, a predetermined high voltage may be output at VCC_12V. The microcontroller 170 may generate a power control signal that has a low voltage at MCU_VCC_EN, and provide the low voltage MCU_VCC_EN to the enabling pin of the power converter 44 to disable the power converter 44. As a result of disabling the power converter 44, a low voltage or zero voltage may be generated at VCC_12V.

In some embodiments, the power source 140 may include the battery V_BAT shown in FIG. 4, the MOS switch shown in FIG. 4, and an enabling circuit including the circuit shown in FIG. 4 and the circuit shown in FIG. 5. The MOS switch may be coupled to the battery V_BAT, and may be configured to be changeable between a connected state and a disconnected state to allow and disallow the power to be supplied from the battery to the electronic device, the switch being controllable by a controller, such as the microcontroller 170.

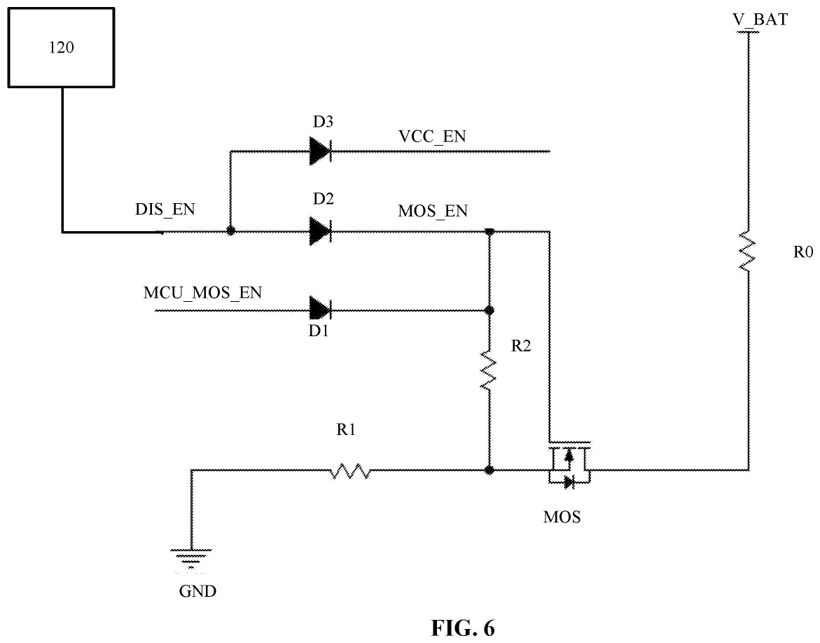

FIG. 6 is a circuit diagram of another embodiment of the first portion of the power control circuit 180. The circuit portion shown in FIG. 4 uses resistor R1 (an embodiment of a detecting element) to detect a signal (e.g., a high voltage signal) generated due to the UAV 100 being in an inflight state. The detected signal is used by the operational amplifiers to generate an enabling signal (e.g., of a high voltage) at DIS_EN for activating the MOS switch and for enabling the power converter 44 shown in FIG. 5. FIG. 6 shows an alternative circuit for providing an enabling signal (e.g., of a high voltage) at DIS_EN. The circuit node at DIS_EN may be connected to an output pin at the flight control device 120. The flight control device 120 may output a signal of a predetermined voltage level (e.g., a high voltage of 3.3V, 5.0V, 9V, 12V, etc.) when the UAV 100 is in flight to indicate the flight status of the UAV 100. Thus, when the UAV 100 is in flight, DIS_EN may be maintained at a constantly high voltage. As a result, MOS_EN may be maintained at a constantly high voltage. Therefore, the MOS switch may be constantly maintained in an activated or connected state, allowing the power from the battery (V_BAT) to be constantly supplied to the load (R0), such as the propulsion system 110. A constant power supply to the propulsion system can avoid crash caused by the loss of power in the propulsion system 110. In addition, the high voltage at DIS_EN also results in a high voltage at VCC_EN, which is supplied to the enabling pin (EN) of the power converter 44 shown in FIG. 5 to enable the power converter 44. When the power converter 44 is constantly enabled by the constant high voltage VCC_EN, a predetermined voltage is constantly provided at VCC_12V, which may be required by various components, devices, circuits, or electrical elements in the power control circuit 180 for generating the enabling signal for maintaining the MOS switch in a constantly connected state.

When the UAV 100 is not in flight, e.g., when landed on the ground, the flight control device 120 may output a low voltage at DIS_EN. When the voltage at DIS_EN is low, the circuit branch comprised of DIS_EN and D2 is disconnected, and MOS switch may be controlled by the microcontroller 170 by supplying different signals at MCU_MOS_EN. If the microcontroller 170 supplies a signal of a high voltage at MCU_MOS_EN, MOS_EN is a high voltage signal, and the MOS switch is enabled (activated or connected). If the microcontroller 170 supplies a signal of a low voltage at MCU_MOS_EN, the MOS switch may be deactivated or disconnected, thereby terminating the power supply to the load (R0) from the battery (V_BAT).

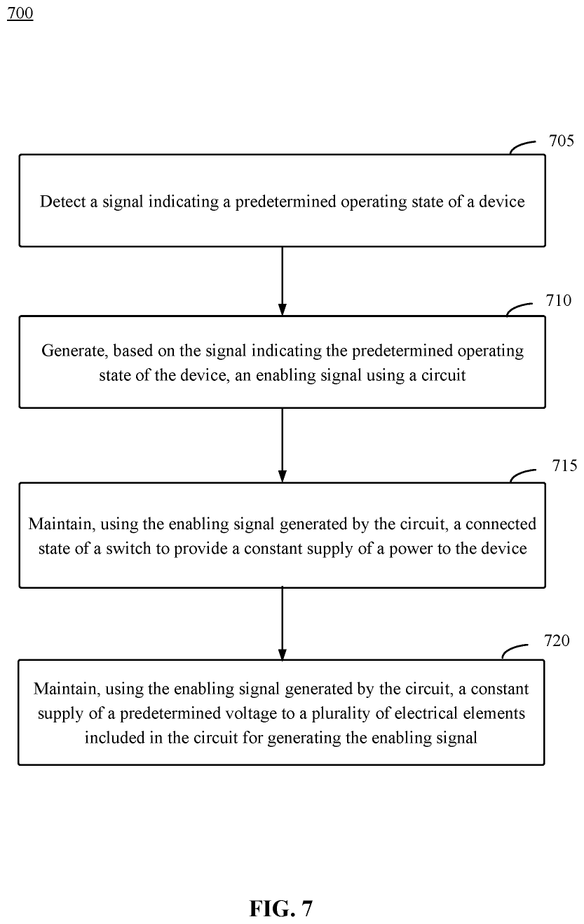

FIG. 7 is a flow chart illustrating a method for managing the power supply to an electronic device, such as UAV 100. Method 700 may be performed by a processor or controller included in the UAV 100. For example, the method 700 may be performed by a processor included in the flight control device 120. In some embodiments, the method 700 may be performed by the power control circuit 180. For example, various electrical elements or circuit portions of the power control circuit 180 may be configured to perform various steps of method 700. In some embodiments, the method 700 may be performed by the power source 140, which may include the power control circuit 180. In some embodiments, the power source 140 may include a chip having one or more processors to process various data or signals for managing the power supply to the load of the UAV 100.

Method 700 may include detecting a signal indicating a predetermined operating state of a device (step 705). In some embodiments, the predetermined operating state may be an activation of the device (e.g., a power-on state of the device, a working state of the device, etc.). In some embodiments, when the device is a UAV, the predetermined operating state may be the inflight state of the UAV. In some embodiments, detecting the signal indicating the predetermined operating state may include measuring an electrical parameter of a detecting element. In some embodiments, the electrical parameter may include at least one of a current or a voltage. In some embodiments, the detecting element may include a resistor, such as resistor R1.

For example, when the voltage across the resistor R1 is greater than a predetermined voltage, the measured voltage across the resistor R1, which may be amplified by Op-Amp_1 as Vout, may indicate that the UAV 100 is in an inflight state (e.g., an activation state). As another example, when a surgical device is activated, the surgical device may output a signal indicating an activation state or a working state of the surgical device. A processor may receive the signal indicating that the surgical device has been activated.

In some embodiments, detecting the signal indicating the predetermined operating state of the device may include detecting the signal indicating the predetermined operating state by a sensor. The sensor may include at least one of an inertial measurement sensor, a speed sensor, an altitude sensor, a distance sensor, or an accelerometer. In some embodiments, detecting the signal indicating the predetermined operating state of the device may include communicating with an external remote control terminal to obtain the signal indicating the predetermined operating state. For example, the UAV may communicate with a remote control, and may obtain signals, data, or commands from the remote control indicating that the UAV is in an inflight state or will be placed in an inflight state.

Method 700 may include generating, based on the signal indicating the predetermined operating state of the device, an enabling signal using a circuit (step 710). In some embodiments, the enabling signal may be the signal provided at DIS_EN shown in FIG. 4. In some embodiments, generating the enabling signal may include generating the enabling signal of a predetermined voltage based on comparing the detected signal with a predetermined reference signal. In some embodiments, comparing the detected signal with the predetermined reference signal may include at least one of comparing a voltage of the detected signal with a voltage of the predetermined reference signal, or comparing a current of the detected signal with a current of the predetermined reference signal. In some embodiments, generating the enabling signal may include generating the enabling signal when the voltage of the detected signal is greater than the voltage of the predetermined reference signal, or when the current of the detected signal is greater than the current of the predetermined reference signal. For example, as shown in FIG. 4, the voltage across resistor R1 may be amplified to produce signal Vout having an amplified voltage, which may be compared with a reference voltage of a reference signal Vref. If voltage of Vout is greater than voltage of Vref, a high voltage enabling signal DIS_EN may be generated.

Method 700 may include maintaining, using the enabling signal generated by the circuit, a connected state of a switch to provide a constant supply of a power to the device (step 715). For example, a high voltage signal at DIS_EN (an example of the enabling signal) may produce a high voltage signal MOS_EN, which may be provided to an input of the MOS switch to enable (or activate, connect) the MOS switch. When the high voltage DIS_EN is maintained, the high voltage MOS_EN is maintained, and the constantly connected state of the MOS switch is maintained, thereby enabling the power from the battery (V_BAT) to be constantly supplied to the load (R0) of the UAV 100.

Method 700 may include maintaining, using the enabling signal generated by the circuit, a constant supply of a predetermined voltage to a plurality of electrical elements included in the circuit for generating the enabling signal (step 720). For example, the high voltage signal at DIS_EN may be supplied as VCC_EN to an enabling pin of the power converter 44 shown in FIG. 5 to maintain the power converter 44 in an enabled state, thereby enabling the power converter 44 to constantly provide a predetermined voltage at VCC_12V, which may be required for normal operations and functioning of various electrical elements (e.g., the Op-Amps and R2) included in the power control circuit 180 for generating the enabling signal for maintaining the connected state of the MOS switch.

In some embodiments, when the enabling signal maintains the switch in the connected state, control of the switch by the switch control signal generated by the microcontroller 170 is disabled. In some embodiments, maintaining, using the enabling signal generated by the circuit, the constant supply of the predetermined voltage to the plurality of electrical elements may include supplying the enabling signal to an enabling pin of the power converter 44 to enable the power converter 44 to constantly supply the predetermined voltage to the plurality of electrical elements for generating the enabling signal. In some embodiments, supplying the enabling signal to the enabling pin of the power converter 44 may include supplying the enabling signal to the enabling pin of the power converter 44 in parallel with a power control signal generated by the microcontroller 170 and supplied to the enabling pin of the power converter 44.

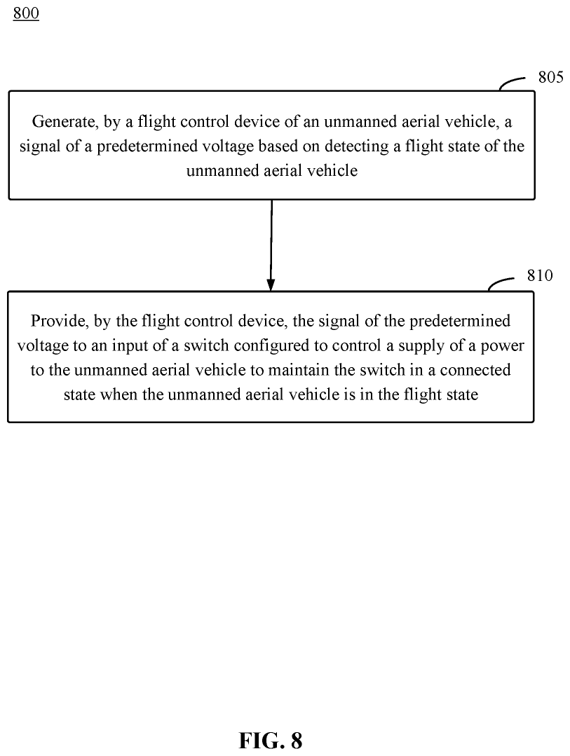

FIG. 8 is a flow chart illustrating a method for managing the power supply to an electronic device, such as UAV 100. Method 800 may be performed by a processor or controller included in the UAV 100. For example, the method 800 may be performed by a processor included in the flight control device 120. In some embodiments, the method 800 may be performed by the power control circuit 180. For example, various electrical elements and/or circuit portions of the power control circuit 180 may be configured to perform various steps of the method 800. In some embodiments, the method 800 may be performed by the power source 140, which may include the power control circuit 180. In some embodiments, the power source 140 may include a chip having one or more processors to process various data or signals for managing the power supply to the load of the UAV 100.

Method 800 may include generating, by a flight control device of an unmanned aerial vehicle, a signal of a predetermined voltage based on detecting an inflight state of the unmanned aerial vehicle (step 805). For example, as shown in FIG. 6, the flight control device 120 may generate a signal having a high voltage (e.g., at or above a predetermined voltage) when the UAV 100 is in flight. The flight control device 120 may detect that the UAV 100 is in flight based on signals receives from at least one of an inertial measurement sensor, a speed sensor, an altitude sensor, a distance sensor, or an accelerometer. In some embodiments, the flight control device 120 may communicate with an external remote control terminal to obtain the signal indicating that the UAV 100 is in flight. For example, the flight control device 120 may continuously receive flight related commands from the remote control terminal, and may determine that the UAV 100 is in flight based on the flight related commands. In some embodiments, when the UAV 100 is not in flight, the flight control device 120 may generate a signal having a low voltage (e.g., at or below a predetermined voltage).

In some embodiments, method 800 may include providing, by a microcontroller of the unmanned aerial vehicle, a switch control signal to the input of the switch 160 in parallel with the signal of the predetermined voltage provided by the flight control device 120. As shown in FIG. 6, the signal DIS_EN from the flight control device 120 may be provided to the input of the MOS switch in parallel with the signal MCU_MOS_EN generated by the microcontroller 170. In some embodiments, method 700 may include providing the switch control signal to the input of the switch to place the switch in a connected state to initiate the supply of the power to the unmanned aerial vehicle when the unmanned aerial vehicle is not in the inflight state. For example, when not in flight (e.g., prior to take off), the circuit branch having DIS_EN and D2 (hereinafter “first circuit branch”) may be deemed as disconnected due to the low voltage DIS_EN and the high impedance in diode D2. The microcontroller 170 may generate a high voltage MCU_MOS_EN signal and provide the signal to the input of the MOS switch to place the switch in a connected state to initiate the supply of the power from the power source 140 (e.g., V_BAT) to propulsion system 110 (e.g., load R0).

Method 800 may include providing, by the flight control device 120, the signal of the predetermined voltage to an input of a switch configured to control a supply of a power to the unmanned aerial vehicle to maintain the switch in a connected state when the unmanned aerial vehicle is in the inflight state (step 810). For example, as shown in FIG. 6, the flight control device 120 may output the signal having the high voltage to a node DIS_EN in the power control circuit 180. The high voltage signal at DIS_EN may produce a high voltage signal at MOS_EN. Thus, the MOS switch may be enabled (or activated, connected) by MOS_EN. When the flight control device 120 constantly provides a high voltage signal to DIS_EN when the UAV 100 is in flight, the MOS switch may be constantly maintained in the activated (or connected) state, thereby allowing the battery power (V_BAT) to be constantly supplied to the load (R0). The constant power supply to the load, which may include the propulsion system 110, may avoid crash of the UAV 100 that may occur when the propulsion system 110 loses power due to various events, such as bugs in software and/or chip logics.

In some embodiments, when a voltage of DIS_EN provided by the flight control device 120 is constantly high, the voltage of MOS_EN is constantly high. As a result, the MOS switch is placed in a constantly connected state, enabling the power to be constantly supplied to the load R0. When the MOS switch is constantly connected by the power control device 120, the control of the switch by the microcontroller 170 is disabled because even if MCU_MOS_EN has a low voltage, the low voltage signal cannot pass through diode D1, and therefore cannot disconnect the MOS switch. When DIS_EN has a low voltage, the circuit branch DIS_EN and D2 may be disconnected. This may occur when the UAV 100 is not in flight (e.g., thus the voltage across R1 is not sufficiently high to produce a Vout having a voltage that is greater than a voltage of Vref). In such situations, the microcontroller 170 may control the state of the MOS switch by generating a high voltage MCU_MOS_EN to place the MOS switch in a connected state or a low voltage MCU_MOS_EN to place the MOS switch in a disconnected state.

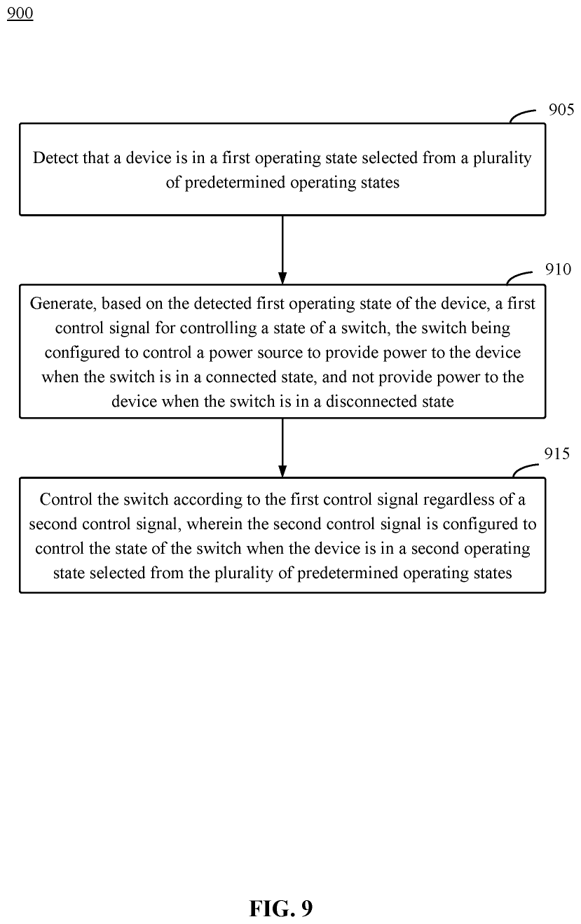

FIG. 9 is a flow chart illustrating a method for controlling a power supply to a device, such as UAV 100. Method 900 may be performed by a processor or controller included in the UAV 100. For example, the method 900 may be performed by a processor included in the flight control device 120. In some embodiments, the method 900 may be performed by the power control circuit 180. For example, various electrical elements and/or circuit portions of the power control circuit 180 may be configured to perform various steps of the method 900. In some embodiments, the method 900 may be performed by the power source 140, which may include the power control circuit 180. In some embodiments, the power source 140 may include a chip having one or more processors to process various data or signals for managing the power supply to the load of the UAV 100.

Method 900 may include detecting that a device is in a first operating state selected from a plurality of predetermined operating states (step 905). The device may be the UAV 100 or any other electronic device that may need a constant or continuous power supply when in operation. Method 900 may also include generating, based on the detected first operating state of the device, a first control signal for controlling a state of a switch, the switch being configured to control a power source to provide power to the device when the switch is in a connected state, and not provide power to the device when the switch is in a disconnected state (step 910). The first operating state may be a state in which a propulsion system of the device (e.g., propulsion system 110 of UAV 100) is operating. For example, when the propulsion system 110 of the UAV 100 is operating, the motor 113 may be rotating. The second operating state may be a state in which the propulsion system of the device is not operating. For example, the second operating state may be a state in which the motor 113 of the propulsion system 110 of the UAV 100 is not operating. In some embodiments, the first operating state may be a state in which the device is airborne (or in flight) and the second operating state may be a state in which the device is not airborne (or not in flight).

In some embodiments, detecting that the device is in the first operating state may include detecting that an electric current flowing through a propulsion system of the device is greater than a predetermined current level. For example, in some embodiments, detecting that the UAV 100 is in flight may include detecting that an electric current flowing through the propulsion system 110 (which may be represented by the load R0 in FIG. 4) is greater than a predetermined current level. The predetermined current level may be a suitable level, such as 20A, 30A, 50A, etc.

In some embodiments, the first control signal is an enabling signal configured to maintain the switch in a connected state. In some embodiments, the second control signal is provided by a controller included in the device. In some embodiments, detecting that the device is in the first operating state may include measuring an electrical parameter of a detecting element connected in series with the device. In some embodiments, the electrical parameter may include at least one of a current or a voltage. In some embodiments, the detecting element may include a resistor. In some embodiments, detecting that the device is in the first operating state may include detecting a signal indicating the first operating state by a sensor. In some embodiments, the sensor may include at least one of an inertial measurement sensor, a speed sensor, an altitude sensor, a distance sensor, or an accelerometer. In some embodiments, detecting that the device is in the first operating state may include communicating with an external remote control terminal to obtain a signal indicating that the device is in the first operating state.

In some embodiments, generating the first control signal may include generating the first control signal of a predetermined voltage based on comparing the detected signal with a predetermined reference signal. In some embodiments, comparing the detected signal with the predetermined reference signal may include at least one of comparing a voltage of the detected signal with a voltage of the predetermined reference signal, or comparing a current of the detected signal with a current of the predetermined reference signal. In some embodiments, generating the first control signal may include generating the first control signal when the voltage of the detected signal is greater than the voltage of the predetermined reference signal, or when the current of the detected signal is greater than the current of the predetermined reference signal.

Method 900 may also include controlling the switch according to the first control signal regardless of a second control signal, wherein the second control signal is configured to control the state of the switch when the device is in a second operating state selected from the plurality of predetermined operating states (step 915). The second control signal may be a control signal generated by the microcontroller 170, e.g., the signal of “MCU_MOS_EN” and/or the signal of “MCU_VCC_EN” shown in FIG. 4. The second operating state may be a state different from the first operating state. For example, when the device is the UAV 100, the second operating state may be a powered off state in which the UAV 100 may be powered off. The second operating state may be a partially powered on or partially powered off state in which the propulsion system 100 is not powered on or at least the motor 113 or the ESC 111 is not powered on.

Method 900 may include other steps. For example, method 900 may include generating a switch control signal by a controller to place the switch in the connected state to supply power from the power source to the device. Method 900 may also include detecting a current output from the power source. Method 900 may further include when the current output from the power source is greater than a predetermined current, generating the first control signal and maintaining, using the first control signal, the connected state of the switch to provide a constant supply of the power to the device, and disabling control of the switch by the controller. In some embodiments, the switch may include a metal oxide semiconductor, and method 900 may include providing the first control signal to an input of the metal oxide semiconductor to maintain the connected state of the metal oxide semiconductor. In some embodiments, method 900 may include providing the first control signal to an input of the switch in parallel with the switch control signal generated by the controller supplied to the input of the switch. In some embodiments, when the first control signal maintains the switch in the connected state, control of the switch by the switch control signal generated by the controller is disabled.

In some embodiments, method 900 may include maintaining, using the first control signal, a constant supply of a predetermined voltage to a plurality of electrical elements by supplying the first control signal to an enabling pin of a power converter to enable the power converter to constantly supply the predetermined voltage to the plurality of electrical elements for generating the first control signal. In some embodiments, supplying the first control signal to the enabling pin of the power converter may include supplying the first control signal to the enabling pin of the power converter in parallel with a power control signal generated by a controller supplied to the enabling pin of the power converter.

In some embodiments, the device is an unmanned aerial vehicle including a propulsion system, and the switch control signal is generated to place the switch in the connected state to initiate the supply of the power to the propulsion system when the unmanned aerial vehicle is not in an inflight state. In some embodiments, the device is an unmanned aerial vehicle including a propulsion system, and wherein detecting that the device is in the first operating state comprises detecting a voltage across a detecting element generated due to a power being supplied to the propulsion system is greater than a predetermined voltage value.

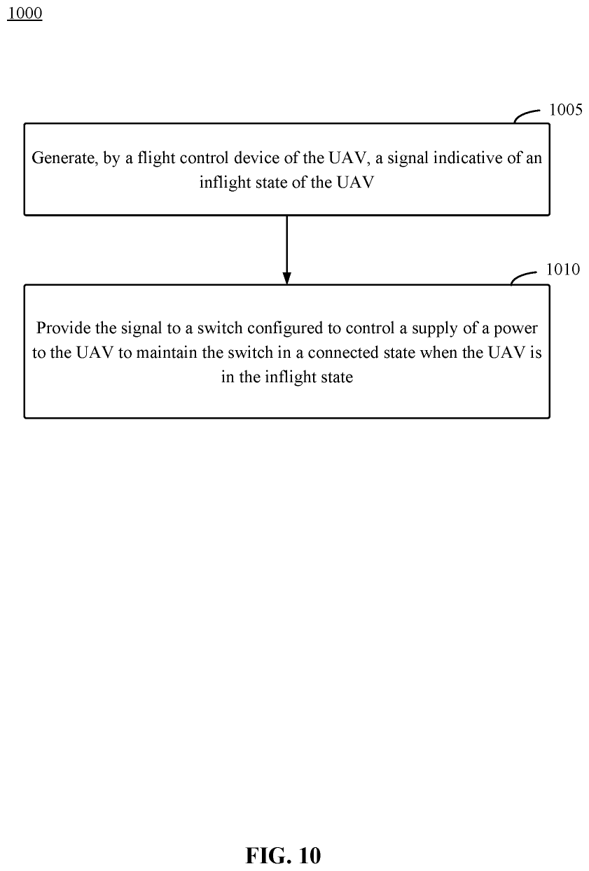

FIG. 10 is a flow chart illustrating a method for controlling a UAV. Method 1000 may be performed by various devices, including processors and circuits, provided on the UAV. Method 1000 may include generating, by a flight control device of the UAV, a signal indicative of an inflight state of the UAV (step 1005). For example, the flight control device 120 may generate a signal indicative of an inflight state of the UAV 100. Method 1000 may also include providing the signal to a switch configured to control a supply of a power to the UAV to maintain the switch in a connected state when the UAV is in the inflight state (step 1010). For example, the flight control device 120 may provide the signal to the MOS switch shown in FIG. 4 to control the battery V_BAT to supply power to the UAV, such as the propulsion system 110 (which may be represented by load R0 shown in FIG. 4) of the UAV 100. In some embodiments, the signal generated by the flight control device 120 may be provided as “DIS_EN” shown in FIG. 6.

While embodiments of the present disclosure have been shown and described herein, it will be obvious to those skilled in the art that such embodiments are provided by way of example only. Numerous variations, changes, and substitutions will now occur to those skilled in the art without departing from the present disclosure. It should be understood that various alternatives to the embodiments of the invention described herein may be employed in practicing the present disclosure. It is intended that the following claims define the scope of the invention and that methods and structures within the scope of these claims and their equivalents be covered thereby.

What is claimed is:

1. An unmanned aerial vehicle (UAV), comprising:
a propulsion system configured to provide a propulsion force for flight of the UAV;
a power source configured to supply power to the propulsion system;
a controller configured to control the power source when the UAV is not in flight; and
a power control circuit coupled with at least one of the propulsion system, the power source, or the controller, and configured to override the control of the power source by the controller when the UAV is in flight.

2. The unmanned aerial vehicle of claim 1, wherein the power control circuit comprises:
a switch coupled with at least one of the power source, the controller, or the propulsion system, and configured to allow or disallow the power to be supplied from the power source to the propulsion system.

3. The unmanned aerial vehicle of claim 2, wherein the power control circuit further comprises:
a first circuit comprising a detecting element and a comparator, the first circuit configured to:
detect a signal generated due to the power being supplied to the propulsion system;
compare the detected signal with a predetermined reference signal; and
generate an enabling signal of a predetermined voltage based on comparing the detected signal with the predetermined reference signal.

4. The unmanned aerial vehicle of claim 3,
wherein detecting the signal comprises at least one of detecting a voltage across the detecting element or detecting a current flowing through the detecting element, and
wherein comparing the detected signal with the predetermined reference signal comprises at least one of comparing the voltage across the detecting element with a voltage of the predetermined reference signal or comparing the current flowing through the detecting element with a current associated with the predetermined reference signal.

5. The unmanned aerial vehicle of claim 3, wherein the detecting element comprises a resistor.

6. The unmanned aerial vehicle of claim 3, wherein the power control circuit further comprises:
a second circuit comprising:
a first circuit branch configured to supply the enabling signal of the predetermined voltage to an input of the switch; and
a second circuit branch disposed in parallel with the first circuit branch and configured to supply a switch control signal generated by the controller to the input of the switch.

7. The unmanned aerial vehicle of claim 6, wherein the second circuit further comprises:
a third circuit branch configured to supply the enabling signal of the predetermined voltage to an enabling pin of a power converter configured to supply a predetermined voltage to a plurality of elements in the power control circuit.

8. The unmanned aerial vehicle of claim 7, wherein the third circuit branch is disposed in parallel with a fourth circuit branch configured to supply a power control signal generated by the microcontroller to the enabling pin of the power converter.

9. The unmanned aerial vehicle of claim 7, wherein the power converter is a direct-current to direct-current (“DC-to-DC”) power converter.

10. The unmanned aerial vehicle of claim 2, wherein the switch is an analog switch and comprises a metal oxide semiconductor.

11. The unmanned aerial vehicle of claim 2, further comprising:
a sensor configured to provide a signal indicating that the UAV is in flight,
wherein the sensor comprises at least one of an inertial measurement sensor, a speed sensor, an altitude sensor, a distance sensor, or an accelerometer.

12. The unmanned aerial vehicle of claim 2, further comprising:
a flight control device configured to control flight of the UAV, and to provide a signal indicating that the UAV is in flight to the power control circuit as an enabling signal of a predetermine voltage to maintain the switch in a connected state.

13. The unmanned aerial vehicle of claim 12, wherein the power control circuit comprises:
a first circuit branch configured to supply the enabling signal of the predetermined voltage to an input of the switch; and
a second circuit branch disposed in parallel with the first circuit branch and configured to supply a switch control signal generated by the controller to the input of the switch.

14. The unmanned aerial vehicle of claim 2, wherein the controller is configured to generate a switch control signal to place the switch in a connected state to allow the power to be supplied to from the power source to the propulsion system.

15. The unmanned aerial vehicle of claim 2, wherein the power control circuit is configured to generate and provide an enabling signal to the switch to maintain the switch in a connected state based on a signal detected in the power control circuit indicating that the UAV is in flight.

16. The unmanned aerial vehicle of claim 15, wherein control of the switch by the controller is disabled in response to the power control circuit maintaining the switch in the connected state to allow a constant supply of the power from the power source to the propulsion system while the UAV is in flight.
